(19) United States
(12) Patent Application Publication
(10) Pub. No.: US 2011/0088093 A1
(43) Pub. Date: Apr. 14, 2011

(54) USB CONNECTOR AND INTRUSION PREVENTION SYSTEM USING THE SAME

(75) Inventors: Dong Ho KANG, Daejeon (KR); Ki Young Kim, Daejeon (KR); Dong Il Seo, Daejeon (KR)

(73) Assignee: ELECTRONICS AND TELECOMMUNICATIONS RESEARCH INSTITUTE, Daejeon (KR)

(21) Appl. No.: 12/838,060

(22) Filed: Jul. 16, 2010

(30) Foreign Application Priority Data
Oct. 9, 2009 (KR) 10-2009-0096415

(51) Int. Cl. G06F 11/00; G06F 21/00

(52) U.S. Cl. 726/22

(57) ABSTRACT

A security USB connector implements an intrusion prevention function preventing the propagation of malicious codes to a host terminal from a USB device while minimizing host terminal resource consumption, and an intrusion prevention system using the same are disclosed. A security USB connector is positioned between the host terminal supporting a USB host and a USB device, and a security inspection is performed on data transferred from the USB device to the host terminal through the security USB connector. Also, a host terminal without an intrusion prevention function can prevent an intrusion by using the portable security USB connector.

### CROSS-REFERENCE TO RELATED APPLICATIONS

This application claims the priority of Korean Patent Application No. 10-2009-0096415 filed on Oct. 9, 2009, in the Korean Intellectual Property Office, the disclosure of which is incorporated herein by reference.

### BACKGROUND OF THE INVENTION

1. Field of the Invention

The present invention relates to a security USB connector capable of performing an intrusion prevention function while minimizing host terminal resource consumption and being easily installed in any host terminal through its portability, and an intrusion prevention system using the same.

2. Description of the Related Art

Recently, the propagation malicious codes and the infection and damaging of host terminals therewith have been increasing. Such security incidents occur as malicious codes are propagated from an external source via the Internet, a USB device, and the like, to thereby infect host terminals.

Thus, various security software items are employed in order to protect host terminals against such malicious codes.

Existing security software, which is installed so as to operate in host terminals, monitors various external interfaces connected to the host terminals in real time so as to detect and interrupt, or cut off, an introduced malicious code, or operates periodically or asynchronously so as to perform a security inspection in order to detect and remove a malicious code which has intruded into the host terminals.

Thus, the existing security software continuously consumes system resources for real time monitoring and security inspections, negatively affecting the performance of the system, and as one or more security software items are installed for each function, system resources are unnecessarily wasted.

Meanwhile, if a system is used without having security software installed therein, malicious codes would intrude into the system, causing damage to the system.

In addition, recently, the increase in the use of USB-enabled communication devices such as Wi-Fi, Bluetooth™ USB dongle, and the like, speeds up the propagation of malicious codes through such USB devices.

### SUMMARY OF THE INVENTION

An aspect of the present invention provides a security USB connector capable of implementing an intrusion prevention function preventing the propagation of malicious codes to a host terminal from a USB device while minimizing host terminal resource consumption, and an intrusion prevention system using the same.

Another aspect of the present invention provides a security USB connector having portability so as to be easily installed in any host terminal to prevent an intrusion, and an intrusion prevention system using the same.

According to an aspect of the present invention, there is provided a security USB connector including: a security policy database (DB) storing a security policy; a USB transceiver supporting data transmission and reception between a host terminal and a USB device, and stopping data transmission and reception between the host terminal and the USB device if USB data transmitted from the USB device contains a malicious code; a contents filter inspecting whether or not the USB data contains a malicious code based on the security policy stored in the security policy DB when the data provided from the USB transceiver is the USB data; and two or more USB interfaces physically connecting with the host terminal and the USB device, respectively.

The security USB connector may couple the USB device to the host terminal.

If the USB data is transmitted from the USB device, the USB transceiver may provide an information event to the host terminal and request that the host terminal terminate a corresponding session with the USB device.

If the data provided from the USB transceiver is a security policy, the contents filter may have an additional function of updating the security policy DB through the security policy.

The contents filter may include: a data inspector inspecting the USB data through the security policy stored in the security policy DB to check whether or not the USB data contains a malicious code; and a parser parsing data provided from the USB transceiver, transferring the parsed data to the data inspector if the parsed data is the USB data, and updating the security policy DB through the parsed data if the parsed data is the security policy.

According to another aspect of the present invention, there is provided an intrusion prevention system including: a host terminal having a USB host function; a USB device storing and providing USB data; and a security USB connector physically coupling the host terminal to the USB device, and transferring the USB data from the USB device to the host terminal only when the USB data does not have a malicious code.

The host terminal may include: a security USB manager gathering a security policy and transferring the gathered security policy to the security USB connector.

The security USB manger may gather alarm event information with respect to the security USB connector and process it.

The security USB connector may include: a security DB storing the security policy; a USB transceiver supporting data transmission and reception between a host terminal and a USB device, and stopping data transmission and reception between the host terminal and the USB device if USB data transmitted from the USB device contains a malicious code; a contents filter inspecting whether or not the USB data contains a malicious code based on the security policy stored in the security policy DB when the data provided from the USB transceiver is the USB data, and updating the security policy DB through data provided from the USB transceiver if the data provided from the USB transceiver is the security policy; and two or more USB interfaces physically connecting with the host terminal and the USB device, respectively.

If the USB data contains a malicious code, the USB transceiver may request that the host terminal terminate a corresponding session with the USB device, and the host terminal then terminates the session with the USB device in response to the request.

The contents filter may include: a data inspector inspecting the USB data through the security policy stored in the security policy DB to check whether or not the USB data contains a malicious code; and a parser parsing data provided from the USB transceiver, transferring the parsed data to the data inspector if the parsed data is the USB data, and updating the security policy DB through the parsed data if the parsed data is the security policy.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic block diagram showing the configuration of an intrusion prevention system using a security USB connector according to an exemplary embodiment of the present invention;

FIG. 2 is a detailed view showing the configuration of the security USB connector according to an exemplary embodiment of the present invention; and

FIG. 3 is a flow chart illustrating the process of a method for preventing an intrusion through a security USB connector according to an exemplary embodiment of the present invention.

### DETAILED DESCRIPTION OF THE PREFERRED EMBODIMENT

Exemplary embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art.

In the drawings, the shapes and dimensions may be exaggerated for clarity, and the same reference numerals will be used throughout to designate the same or like components.

It will be understood that when an element is referred to as being “connected with” another element, it can be directly connected with the other element or intervening elements may also be present. In contrast, when an element is referred to as being “directly connected with” another element, there are no intervening elements present. In addition, unless explicitly described to the contrary, the word “comprise” and variations such as “comprises” or “comprising,” will be understood to imply the inclusion of stated elements but not the exclusion of any other elements.

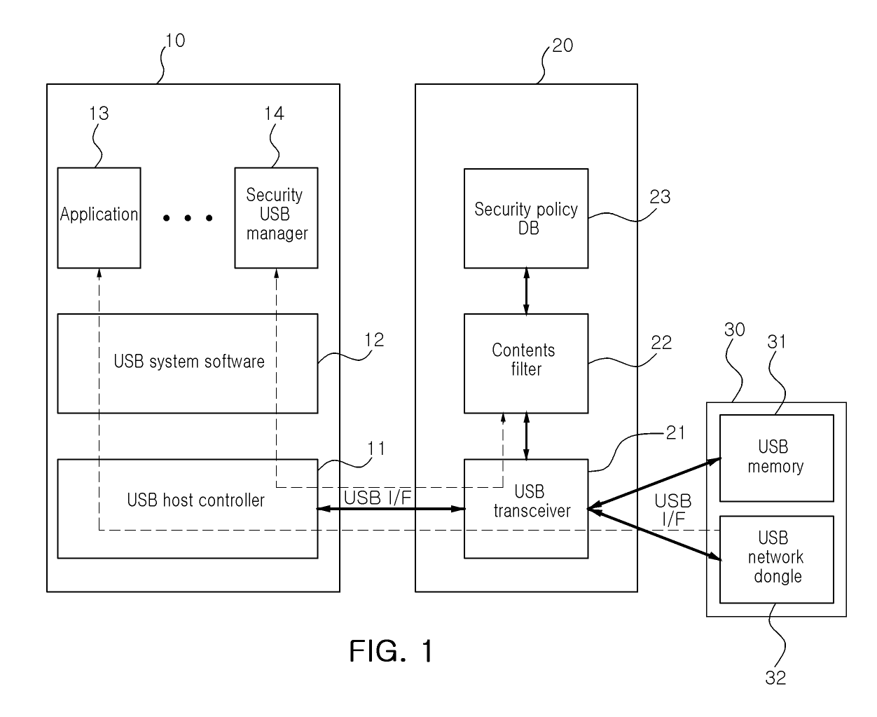

FIG. 1 is a schematic block diagram showing the configuration of an intrusion prevention system using a security USB connector according to an exemplary embodiment of the present invention.

As shown in FIG. 1, an intrusion prevention system according to an exemplary embodiment of the present invention includes a host terminal 10 that supports a USB host and is a object of an intrusion prevention, a security USB connector 20 providing an intrusion prevention function along with a USB connection function, and a USB device 30 connected with the host terminal 10 via the security USB connector 20.

The host terminal 10 may include any electronic device providing a USB host function such as a computer, a notebook(laptop) computer, a PDA, and the like, and the USB device 30 may include a USB memory 31 storing and providing USB data, a USB network dongle 32 supporting a communication function such as Bluetooth™, Wi-Fi, and the like.

The security USB connector 20 may be physically and electrically connected with the host terminal 10 and the USB device 30. The security USB connector 20 finally allows the host terminal 10 and the USB device 30 to be electrically connected therethrough. Like the USB device 30, the security

USB connector 20 is also user-portable.

With reference to FIG. 1, the host terminal 10 includes a USB host controller 11 supporting a USB host function, USB system software 12 and various applications 13 for performing various functions. In addition, the host terminal 10 further includes a security USB manager 14 that gathers a security policy and transfers it to the USB security connector 20, gathers alarm event information generated from the security USB connector 20 and processes the generated alarm event. The security USB manager 14 is installed in the form of software and operated in the host terminal 10.

The security USB connector 20 is mounted outside the host terminal 10. The security USB connector 20 is implemented in portable form, rather than being a fixed type.

After the security USB connector 20 is physically and electrically coupled with the USB device 30 and the host terminal 10, it interworks with the security USB manager 14 of the host terminal 10 to periodically receive a security policy to update an internal security policy, performs a security inspection on USB data transferred from the USB device 30 to the host terminal 10 with reference to the internal security policy, prevents USB data having a malicious code from being transferred to the host terminal 10, and transfers only authenticated, authorized USB data to the host terminal 10.

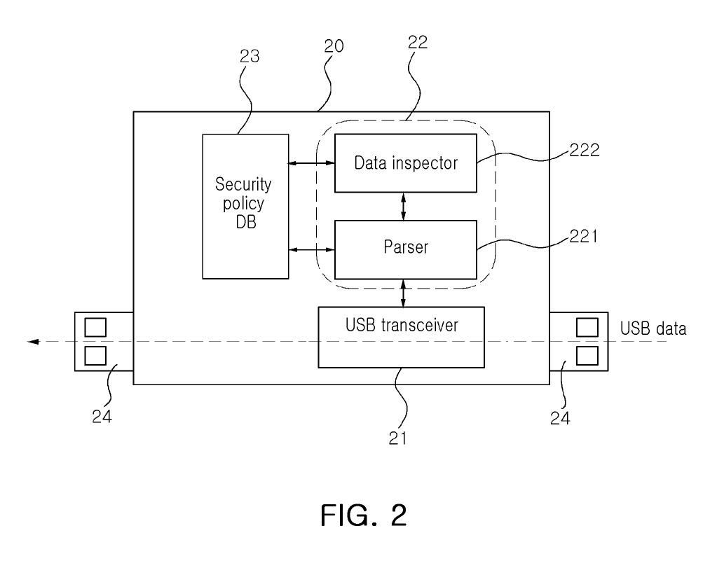

FIG. 2 is a detailed view showing the configuration of the security USB connector according to an exemplary embodiment of the present invention.

With reference to FIG. 2, the security USB connector includes a USB transceiver 21, a contents filter 22, a security policy DB 23, and a USB interface (I/F) 24.

The USB transceiver 21 is physically and electrically coupled with the host terminal 10 and the USB device 30 via the USB interface 24 in order to control a data transmission and reception between the USB device 30 and the host terminal 10. In detail, when transmission data generated by the host terminal 10 or the USB device 30 is input, the USB transceiver first performs a security inspection on the transmission data through the contents filter 22. If it is determined that the transmission data is authenticated USB data which does not contain a malicious code, according to the security inspection result, the USB transceiver 21 transfers the transmission data to the host terminal 10, and if it is determined that the transmission data is USB data containing a malicious code, the USB transceiver 21 generates alarm event information for the host terminal 10 and requests that the host terminal 10 terminate a corresponding session, rather than transferring the transmission data to the host terminal 10.

The contents filter 22 performs a security inspection on the transmission data transmitted or received via the security USB connector 20 according to the security policy stored in the security policy DB 23. To this end, the contents filter 22 includes a parser 221 parsing the transmission data transmitted or received via the security USB connector 20, updating the security policy DB 23 through the parsed transmission data if the parsed transmission data is a security policy, and transferring the parsed transmission data to a data inspector 222 if the parsed transmission data is USB data, and the data inspector 222 inspecting the USB data based on a signature with reference to the security policy stored in the security policy DB 23 to determine whether or not the USB data contains a malicious code.

The security policy DB 23 stores and provides the security policy including a signature used as a reference for determining a malicious code. The content of the security policy DB 23 is updated according to the security policy provided by the security USB manager 14 of the host terminal 10.

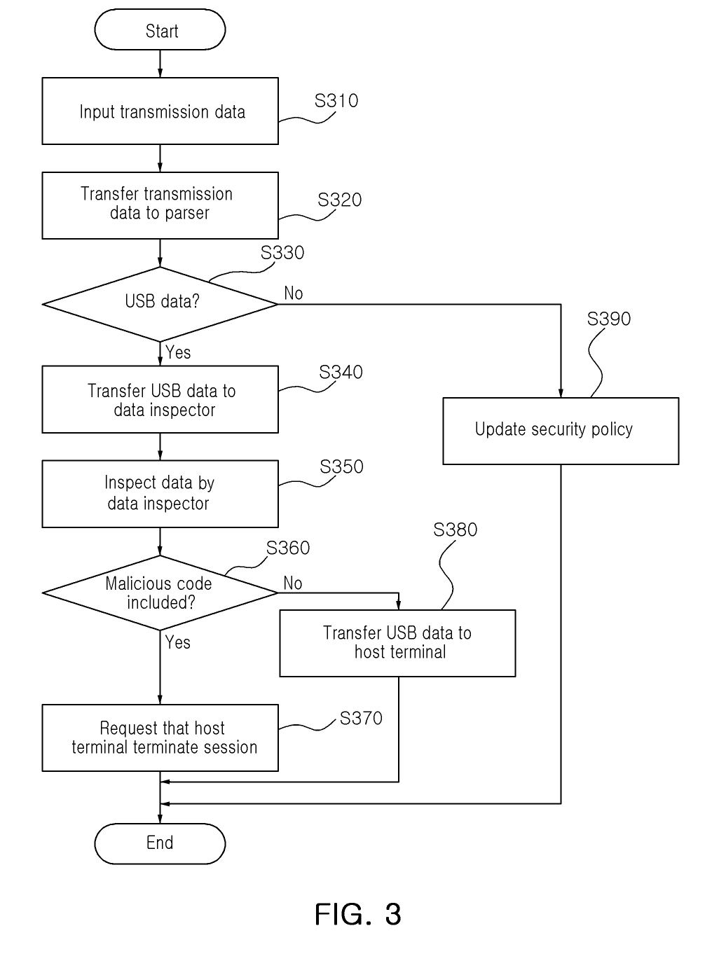

A method for preventing an intrusion using the security USB connector according to an exemplary embodiment of the present invention will now be described with reference to FIG. 3.

FIG. 3 is a flow chart illustrating the process of a method for preventing an intrusion through a security USB connector according to an exemplary embodiment of the present invention.

In a state in which the host terminal 10 and the USB device 30 are electrically coupled through the security USB connector 20, when transmission data is input by the USB device 30 or the host terminal 10 (S310), the USB transceiver 21 of the security USB connector 20 transfers the input transmission data to the parser 221 of the contents filter 22 (S320).

The parser 221 parses the transmission data so as to determine whether or not the parsed transmission data is USB data which has been transmitted from the USB device 30 or policy data which has been transmitted from the security USB manager 14 of the host terminal 10 (S330).

If the parsed transmission data is USB data which has been transmitted from the USB device 30 according to the determination result of step s330, the parser 221 transfers the parsed transmission data to the data inspector 222 of the contents filter 22 (S340).

The data inspector 222 inspects whether or not the USB data contains a malicious code by utilizing the security policies stored in the security policy DB 23 (S350).

If the USB data contains a malicious code according to the inspection result of step S360 (S360), the USB transceiver 21 provides alarm event information to the host terminal 10 in response and requests that the host terminal 10 terminate a corresponding session with the USB device 30 (S370). Accordingly, the transfer of the USB data containing a malicious code is cut off, thus preemptively preventing the propagation of the malicious code to the host terminal 10 from the USB device 30.

Meanwhile, if the USB data does not contain a malicious code according to the inspection result of step S360 (S360), the USB transceiver 21 requests a data transfer to the host terminal 10, and transfers the USB data (S380). Thus, when the transmission data is authenticated or proper data, the host terminal 10 receives the data from the USB device 30.

Meanwhile, if the parsed transmission data is policy data which has been transmitted from the security USB manager of the host terminal 10, the security policy DB 23 is updated by the parsed transmission data (S390).

As described above, in the present invention, after the USB device 30 and the host terminal 10 are electrically coupled through the security USB connector 20, a malicious code introduced from the USB device 30 is cut off through the security USB connector 20, whereby the security function can be performed without consuming the resources of the host terminal itself. Thus, the security of a host terminal can be confirmed without degrading the performance of a computer.

In addition, because the security USB connector 20 is applicable to any type of host terminal 10 having a USB host function, when a host terminal without security software is intended to be used, the security USB connector can be simply coupled thereto to provide the security function as described above.

As set forth above, according to exemplary embodiments of the invention, because the security USB connector has an intrusion prevention function by itself, when a host system and a USB device are coupled through the security USB connector, a malicious code potentially propagated from the USB device to the host terminal can be cut off through the security USB connector without having to use extra security software installed in the host system.

Thus, host terminal resource consumption due to the installation of security software can be minimized and a malicious code propagated from the USB device to the host terminal can be effectively prevented through the intrusion prevention function provided by the security USB connector.

In addition, because the security USB connector is portable by users, it can be easily installed in any host terminal to prevent an intrusion by a USB device.

While the present invention has been shown and described in connection with the exemplary embodiments, it will be apparent to those skilled in the art that modifications and variations can be made without departing from the spirit and scope of the invention as defined by the appended claims.

What is claimed is:

1. A security USB connector comprising:
a security policy database (DB) storing a security policy;
a USB transceiver supporting data transmission and reception between a host terminal and a USB device, and stopping data transmission and reception between the host terminal and the USB device if USB data transmitted from the USB device contains a malicious code;
a contents filter inspecting whether or not the USB data contains a malicious code based on the security policy stored in the security policy DB when the data provided from the USB transceiver is the USB data; and
two or more USB interfaces physically connecting with the host terminal and the USB device, respectively.

2. The USB connector of claim 1, wherein the security USB connector couples the USB device to the host terminal.

3. The USB connector of claim 1, wherein if the USB data transmitted from the USB device contains a malicious code, the USB transceiver provides alarm event information to the host terminal and requests that the host terminal terminate a corresponding session with the USB device.

4. The USB connector of claim 1, wherein if the data provided from the USB transceiver is a security policy, the contents filter has an additional function of updating the security policy DB through the security policy.

5. The USB connector of claim 4, wherein the contents filter comprises:
a data inspector inspecting the USB data through the security policy stored in the security policy DB to check whether or not the USB data contains a malicious code; and
a parser parsing data provided from the USB transceiver, transferring the parsed data to the data inspector if the parsed data is the USB data, and updating the security policy DB through the parsed data if the parsed data is the security policy.

6. An intrusion prevention system comprising:
a host terminal having a USB host function;
a USB device storing and providing USB data; and
a security USB connector physically coupling the host terminal to the USB device, and transferring the USB data from the USB device to the host terminal only when the USB data does not have a malicious code.

7. The intrusion prevention system of claim 6, wherein the host terminal comprises a security USB manager gathering a security policy and transferring the gathered security policy to the security USB connector.

8. The intrusion prevention system of claim 7, wherein the security USB manger gathers alarm event information with respect to the security USB connector and process the gathered alarm event.

9. The intrusion prevention system of claim 8, wherein the security USB connector comprises:
a security database (DB) storing the security policy;
a USB transceiver supporting data transmission and reception between a host terminal and a USB device, and stopping data transmission and reception between the host terminal and the USB device if USB data transmitted from the USB device contains a malicious code;
a contents filter inspecting whether or not the USB data contains a malicious code based on the security policy stored in the security policy DB when the data provided from the USB transceiver is the USB data, and updating the security policy DB through data provided from the USB transceiver if the data provided from the USB transceiver is the security policy; and
two or more USB interfaces physically connecting with the host terminal and the USB device, respectively.

10. The intrusion prevention system of claim 9, wherein if the USB data contains a malicious code, the USB transceiver requests the host terminal that terminate a corresponding session with the USB device, and the host terminal then terminates the session with the USB device in response to the request.

11. The intrusion prevention system of claim 9, wherein the contents filter comprises:
a data inspector inspecting the USB data through the security policy stored in the security policy DB to check whether or not the USB data contains a malicious code; and
a parser parsing data provided from the USB transceiver, transferring the parsed data to the data inspector if the parsed data is the USB data, and updating the security policy DB through the parsed data if the parsed data is the security policy.
